(19) United States
(12) Patent Application Publication
(10) Pub. No.: US 2022/0279057 A1
(43) Pub. Date: Sep. 1, 2022

(54) RELIABLE TRANSPORT PROTOCOL TRANSLATION TECHNOLOGIES

(71) Applicant: Intel Corporation, Santa Clara, CA (US)

(72) Inventors: Patrick CONNOR, Beaverton, OR (US); Scott P. DUBAL, Oregon City, OR (US); James R. HEARN, Hillsboro, OR (US); Andrew J. HERDRICH, Hillsboro, OR (US); Kapil SOOD, Portland, OR (US)

(21) Appl. No.: 17/746,611

(22) Filed: May 17, 2022

(51) Int. Cl. H04L 69/326; H04L 49/356; H04L 9/40

(52) U.S. Cl. CPC H04L 69/326; H04L 49/358; H04L 63/0428; H04L 63/105; H04L 63/101

(57) ABSTRACT

Examples described herein relate to a network interface device. In some examples, the network interface device is to receive a request to transmit data, based on a first reliable transport protocol, and cause the data to be transmitted in at least one packet, based on a second reliable transport protocol, to a destination device and receive at least one packet, from a sender device, based on the second reliable transport protocol and indicate receipt of the at least one packet, based on the first reliable transport protocol, wherein the first reliable transport protocol is different than the second reliable transport protocol.

### BACKGROUND

A reliable transport protocol is a protocol that attempts to ensure receipt of packets transmitted on a network. An example of a reliable transport protocol is Remote Direct Memory Access (RDMA) over Converged Ethernet (RoCE)). RoCE supports data transmissions using reliable connections for latency-sensitive and data intensive data center applications such as key-value stores, graph stores, artificial intelligence (AI) training, and relational databases. Many cloud service providers (CSPs) are developing proprietary reliable transport protocols, which are also known as resilient reliable transport.

### BRIEF DESCRIPTION OF THE DRAWINGS

FIG. 1 depicts an example system.

FIG. 2 depicts an example system.

FIG. 3 depicts an example system.

FIGS. 4A and 4B depict example processes.

FIGS. 5A and 5B depict example processes.

FIG. 6 depicts an example network interface.

FIG. 7 depicts an example system.

FIG. 8 depicts an example system.

### DETAILED DESCRIPTION

A sender application (e.g., virtualized environment such as virtual machine (VM) or container) may be developed to natively utilize standardized reliable transport protocols, such as RoCE, for communications with a destination or target application or device. Application developers may not develop applications that utilize a CSP's proprietary reliable transport protocol. Reliable transport protocols can support one or more of the following operations: congestion detection and indication of congestion (e.g., Explicit Congestion Notification (ECN), queue depth, link utilization, or in-network telemetry (INT)), round-trip time (RTT) monitoring to identify congestion from increase in RTT, reaction to congestion notification (e.g., reduce or increase packet transmit (TX) rate or adjust congestion window (CWND) size indicative of number of transmitted packets for which acknowledgement of receipt has not been received), selection of a multipath for packet transmission, selective acknowledgement of receipt (ACK) or negative acknowledgment or not acknowledged (NACK), proactively schedule network transfers to avoid congestion (e.g., receiver-driven credit management), selective retransmissions of non-acknowledged packets (e.g., go-back-N and re-transmit N packets), loss detection to detect packet loss (e.g., timeouts after not receiving an ACK within an amount of time, detect duplicate ACKs, receipt of explicit NACKs), or reordering of received packets (e.g., based on packet sequence numbers). Sender communications based on the standardized reliable transport protocol may not be compatible with the CSP's proprietary reliable transport protocol.

At least to provide support for reliable transport protocol APIs utilized by an application and utilize a CSP's reliable transport protocol, translation of communications based on a reliable transport protocol utilized by an application to or from CSP's proprietary reliable transport protocol can occur. For example, applications could utilize RDMA application program interface (API) semantics (e.g., RDMA Verbs), whereas traffic could be transmitted by a cloud native reliable transport such as a CSP's proprietary packet transmission protocol. A translator circuitry can receive or intercept RDMA Verbs API commands from an application, driver, or OS and translate the commands to a format consistent with commands of a CSP's reliable transport protocol. For example, the translation circuitry can convert RoCE format API semantics (or other API semantics) to utilize different proprietary protocols. For example, the translation circuitry can indicate receipt of packets on a proprietary protocol using RoCE format API semantics (or other API semantics). Accordingly, datacenter applications written to utilize RDMA or other reliable transport protocol can utilize RDMA APIs and do not need to be re-written to utilize cloud native datacenter reliable transport protocols.

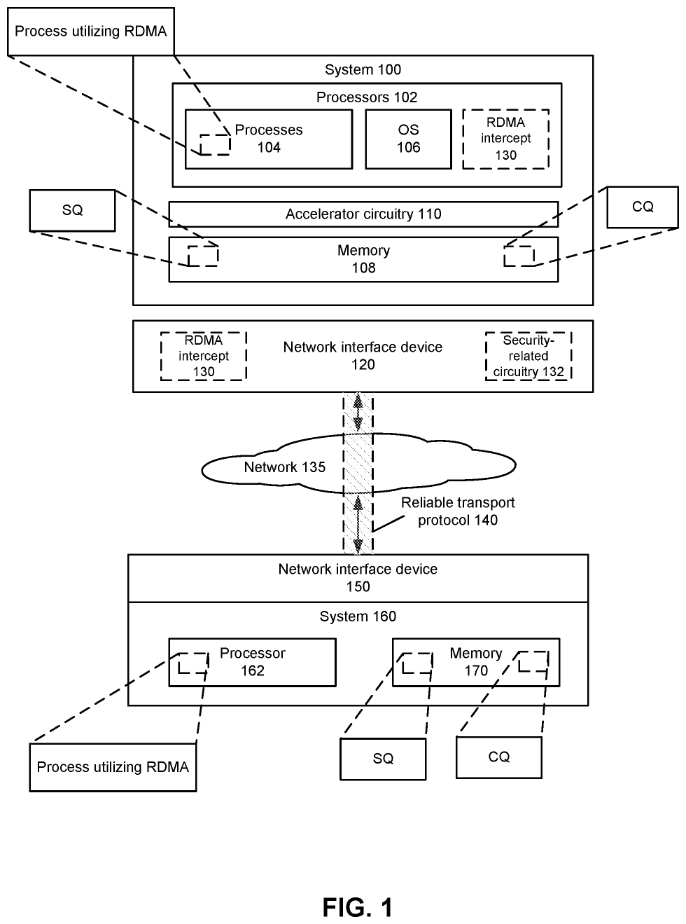

FIG. 1 depicts an example of communications between systems. System 100 can be implemented as part of a server, rack of servers, computing platform, or other systems. In some examples, processors 102 can include one or more of: a central processing unit (CPU) core, graphics processing unit (GPU), field programmable gate array (FPGA), accelerator (e.g., field programmable gate array (FPGA)), and/or or application specific integrated circuit (ASIC). Processors 102 can include an XPU, where an XPU can include at least to: a CPU, a graphics processing unit (GPU), general purpose GPU (GPGPU), or other processing units (e.g., accelerator). In some examples, a processor can be sold or designed by Intel®, ARM®, AMD®, Qualcomm®, Broadcom®, Nvidia®, IBM®, Texas Instruments®, among others.

Processors 102 can execute an operating system (OS), driver, and/or processes. In some examples, an OS can include Linux®, Windows® Server, FreeBSD®, Android®, MacOS®, iOS®, or any other operating system. One or more of processors 102 can execute processes 104. Processes 104 can include one or more of: applications, virtual machines (VMs), microVMs, containers, microservices, serverless applications, and so forth.

A VM can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the client or server's CPU, memory, hard disk, network, and other hardware resources completely, enabling virtual machines to share the resources. The hypervisor can emulate multiple virtual hardware platforms that are isolated from another, allowing virtual machines to run Linux®, Windows® Server, VMware ESXi, and other operating systems on the same underlying physical host.

A container can include a software package of applications, configurations, and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

A microservice can communicate using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, one or more of processes 104 can communicate using remote direct memory access (RDMA) or reliable transport-based communications with a process executed by system 160. For example, one or more of processes 104 can use an InfiniBand consistent Verbs application program interface (API) to establish a queue-pair with a remote process 162 executing on system 160 to enable RDMA writes directly to destination memory 170 while bypassing use of OS 106 to manage copy operations at the receiver. For example, one or more of processes 104 can use an OpenFabrics Alliance Verbs API to initiate an RDMA write to a memory region accessible by an accelerator device. RDMA connectivity can be established using a Verbs API (e.g., RDMA Protocol Verbs Specification (Version 1.0) (2003) and successors, variations, and derivatives thereof). Other protocols can be used such as: InfiniBand, Internet Wide Area RDMA Protocol (iWARP), RDMA over Converged Ethernet (RoCE), routable RDMA over Converged Ethernet (RoCE), Transmission Control Protocol (TCP), User Datagram Protocol (UDP), and others.

RDMA can utilize Queue-Pairs (QPs), which represent a connection between two physical endpoints. A unique QP with send queues, receive queues, and completion queues (CQ) can be utilized per application. When a connection QP is created and while it remains active, the sender and receiver hosts maintain information such as which and how many Transmit and Receive Queues can be used; which Congestion Control (CC) protocol; the Completion Queue; and Memory Regions (MR) associated with a given QP.

One or more of processes 104 can issue or receive API calls to utilize a particular RDMA protocol for packet transmission or receipt and RDMA intercept 130 can provide a translation whereby reliable transport protocol 140 provides reliable communication between network interface device 120 and network interface device 150 but API calls to utilize a different reliable transport protocol. For example, in connection with packet transmission, one or more of processes 104 can issue RDMA APIs to transmit data (e.g., TX packets in memory 108) using network interface device 120 to network interface device 150. As described herein, RDMA intercept 130 can intercept RDMA APIs sent to network interface device 120 or network interface device 120 can copy or forward received RDMA APIs to RDMA intercept 130. RDMA intercept 130 can cause the command associated with the RDMA APIs to be issued in a format consistent with reliable transport protocol 140 utilized in network 135. In connection with packet receipt by network interface device 120 using reliable transport protocol 140, RDMA intercept 130 can issue a corresponding RDMA Verbs APIs to a target process of processes 104 to indicate receipt of RDMA data. In some examples, RDMA intercept 130 can perform conversion of RDMA APIs to APIs that control utilization of reliable transport protocol 140 by network interface device 150 and/or perform conversion of APIs issued by network interface device 150 based on communications, received through reliable transport protocol 140, to RDMA APIs. In some examples, communications based on RDMA APIs are not tunneled using reliable transport protocol 140 to or from network interface device 120. Reliable transport protocol 140 can potentially use different congestion control and multi-pathing than that used by one or more of processes 104.

In some examples, RDMA intercept 130 can translate a RoCE transmit request to a packet consistent with reliable transport protocol 140. For example, where RoCE operations are the same as operations of reliable transport protocol 140, RDMA intercept 130 can apply features specified by RoCE and available from reliable transport protocol 140. For reliable transport protocol 140 operations that RoCE does not provide, RDMA intercept 130 can select available reliable transport protocol 140 operations. For example, where path selection or congestion management of reliable transport protocol 140 differ from those of RoCE, RDMA intercept 130 can select path selection or congestion management available in reliable transport protocol 140.

RDMA intercept 130 can be executed by system 100 as user space or kernel space software and/or executed by network interface device 120. Reliable transport protocol 140 can be implemented as hypervisor or middle layer software executed by one or more processors 102 in system 100 as user space or kernel space software and/or executed by network interface device 120. A reliable transport protocol 140 software stack can be loaded for execution by one or more processors 102 in system 100 and/or for execution by network interface device 120. RoCE applications could bind to reliable transport protocol 140 software stack or RDMA intercept 130. An orchestrator or network administrator could configure RDMA intercept 130 with the source protocol (e.g., RoCE) and target reliable transport protocol 140 so that RDMA intercept 130 can perform translation between source and target protocols.

In some examples, a packet is not formed based on the received RDMA transmit request API but one or more processes 104 registers a remote direct memory access flow (e.g., RoCE, InfiniBand over Ethernet (IBoE), or others) with RDMA intercept 130 and is assigned a port number (e.g., port number 4791). One or more processes 104 can use the assigned port to communicate with the target process executed by system 160 via a network. For packet transmissions, RDMA intercept 130 can monitor the assigned port and cause data to be transmitted to the network as packets by network interface device 120 using reliable transport protocol 140 with reliable transport protocol metadata (e.g., destination memory address, connection identifier, Packet Sequence Number (PSN), ACK request (yes/no), Destination QP, Partition Key, Transport Header Version, Pad Count, Migration request (yes/no), solicited event, Packet OpCode). For packet receipts, RDMA intercept 130 can monitor the assigned port and cause an RDMA received packet API to be issued to one or more of processes 104 to indicate receipt of one or more packets and identify a memory buffer that stores portions of the received one or more packets.

Network interface device 120 can include one or more of: a network interface controller (NIC), a remote direct memory access (RDMA)-enabled NIC, SmartNIC, router, switch, or network-attached appliance.

For example, reliable transport protocol 140 can be specified by a CSP for use in one or more datacenters. Various examples of reliable transport protocol 140 include Amazon's scalable reliable datagram (SRD), Amazon AWS Elastic Fabric Adapter (EFA), Microsoft Azure Distributed Universal Access (DUA) and Lightweight Transport Layer (LTL), Google GCP Snap Microkernel Pony Express, Google Falcon, High Precision Congestion Control (HPCC) (e.g., Li et al., “HPCC: High Precision Congestion Control” SIGCOMM (2019)), quick UDP Internet Connections (QUIC), or other reliable transport protocols. For example, reliable transport protocol 140 can provide one or more of: congestion detection and indication of congestion, multipath packet transmission, selective acknowledgement of receipt (ACK) or negative acknowledgment or not acknowledged (NACK), reordering of received packets, packet retransmission, round-trip time (RTT) monitoring, in-network telemetry (INT), and more.

RDMA intercept 130 can be implemented as software executed by processors 102 and/or processors in network interface device 120. RDMA intercept 130 can be implemented based on a development kit for network interface device 120 such as one or more of: Programming Protocol-independent Packet Processors (P4), Software for Open Networking in the Cloud (SONiC), C, Python, Broadcom Network Programming Language (NPL), NVIDIA® CUDA®, NVIDIA® DOCA™, Infrastructure Programmer Development Kit (IPDK), or others. RDMA intercept 130 can be implemented as firmware utilized by system 100 or network interface device 120. RDMA intercept 130 can be implemented as one or more of: toolkit for developers to configure network interface device 120 (e.g., NVIDIA® CUDA®, NVIDIA® DOCA™, or Infrastructure Programmer Development Kit (IPDK)), services available to processes 104 through an API, and/or accelerator circuitry. The services can be executed by processors 102 and/or a programmable pipeline or processors of network interface device 120.

As described herein, for packets transmitted and received based on a reliable connection, RDMA intercept 130 can track connection state information. Connection state information can include one or more of: transmitted packets for which receipt was acknowledged (ACK), congestion window updates, media access control (MAC) addresses, Internet Protocol (IP) addresses, transmitted RDMA over Converged Ethernet (RoCE) packet sequence number (PSN), or received RoCE PSN.

RDMA intercept 130 can be implemented as a host bus adapter (HBA) or smart end point (EP). An HBA can include a circuit board or integrated circuit adapter that connects to system 100. RDMA intercept 130 can advertise RDMA transmission capability to OS 106 so that one or more of processes 104 can utilize an RDMA API to initiate formation of a reliable connection and request packet transmission via the reliable connection or receive indication of packet receipt via the reliable connection.

In some examples, one or more of processes 104 can execute in a confidential computing environment or secure enclave for which accesses to memory regions associated with a process is restricted to authorized devices or processes and data is stored in encrypted form. A confidential computing environment or secure enclave can be created using one or more of: total memory encryption (TME), multi-key total memory encryption (MKTME), Trusted Domain Extensions (TDX), Double Data Rate (DDR) encryption, function as a service (FaaS) container encryption or an enclave/TD (trust domain), Intel® SGX, Intel® TDX, AMD Memory Encryption Technology, AMD Secure Memory Encryption (SME) and Secure Encrypted Virtualization (SEV), ARM® TrustZone®, Apple Secure Enclave Processor, Qualcomm® Trusted Execution Environment, Peripheral Component Interconnect express (PCIe) LinkSec, and so forth.

Encryption or decryption can use, for example, total memory encryption (TME) and multi-key total memory encryption (MKTME) commercially available from Intel Corporation (as described in the Intel Architecture Memory Encryption Technologies Specification version 1.1 dated Dec. 17, 2017 and later revisions), components that make up TME and MKTME, the manner in which TME and MKTME operate, and so forth. These technologies can be used to provide a readily comprehensible perspective for understanding the various disclosed embodiments and are not intended to limit implementations to employing only TME and MKTME. TME provides a scheme to encrypt data by memory interfaces whereby a memory controller encrypts the data flowing to the memory or decrypts data flowing from memory and provides plain text for internal consumption by the processor.

In some examples, TME is a technology that encrypts a device's entire memory or portion of a memory with a key. When enabled via basic I/O system (BIOS) (or Universal Extensible Firmware Interface (UEFI), or a boot loader) configuration, TME can provide for memory accessed by a processor on an external memory bus to be encrypted, including customer credentials, encryption keys, and other intellectual property (IP) or personal information. TME supports a variety of encryption algorithms and in one embodiment may use a National Institute of Standards and Technology (NIST) encryption standard for storage such as the advanced encryption system (AES) XTS algorithm with 128-bit keys. The encryption key used for memory encryption is generated using a hardened random number generator in the processor and is never exposed to software. Data in memory and on the external memory buses can be encrypted and is in plain text while inside the processor circuitry. This allows existing software to run unmodified while protecting memory using TME. There may be scenarios where it would be advantageous to not encrypt a portion of memory, so TME allows the BIOS (or UEFI or bootloader) to specify a physical address range of memory to remain unencrypted. The software running on a TME-capable system can access portions of memory that are not encrypted by TME.

In some embodiments, TME can support multiple encryption keys (Multi-Key TME (MKTME)) and provides the ability to specify the use of a specific key for a page of memory. This architecture allows either processor-generated keys or tenant-provided keys, giving full flexibility to customers. Processes can be cryptographically isolated from each other in memory with separate encryption keys which can be used in multi-tenant cloud environments. Processes can also be pooled to share an individual key, further extending scale and flexibility.

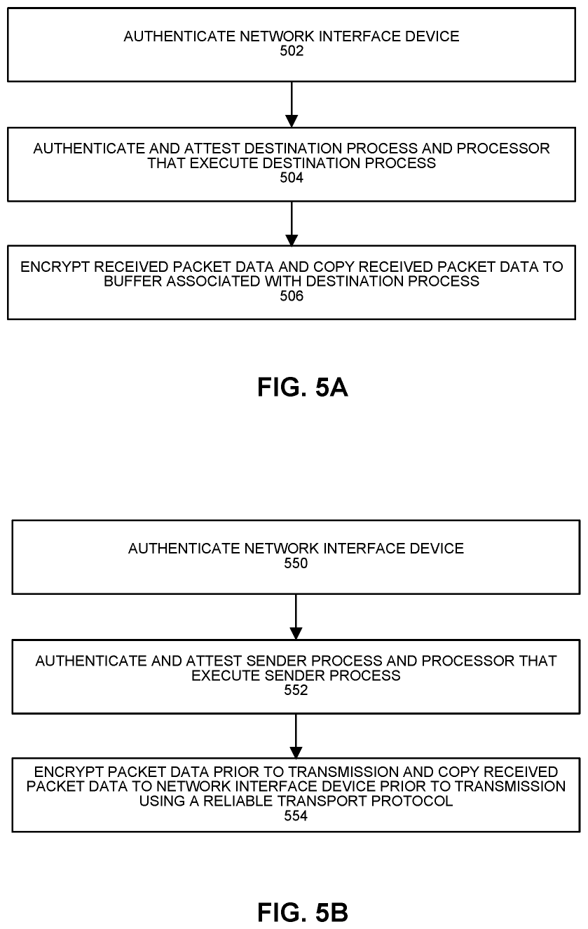

In some scenarios, RDMA processes executing on a processor and/or the network interface device may execute inside a confidential computing environment. In connection with RDMA transmit requests, to attempt to provide for secure interception of RDMA APIs and issuance of corresponding reliable transport protocol commands, authentication and attestation operations described herein can be performed. Similarly, in connection with receipt of packets using a reliable transport protocol, to attempt to provide for secure interception of RDMA APIs and issuance of corresponding reliable transport commands, authentication and attestation operations described herein can be performed with respect to FIGS. 5A and 5B. For example, network interface device 120 can be assigned to an enclave, and OS 106 cannot change applicable security features or memory access credentials but can only remove credentials to security features or memory access credentials of network interface device 120.

Security-related circuitry 132 can authenticate capability of network interface device 120 to read or write data from memory allocated to a process of processes 104 executing in a secure enclave. For example, security-related circuitry 132 can encrypt data from packets received via a reliable transport protocol 140 and copied from network interface device 120 to memory 108. For example, security-related circuitry 132 can decrypt data for packet data to be transmitted via a reliable transport protocol 140 and copied from memory 108 to network interface device 120.

In some examples, system 100 and/or network interface device 150 can include one or more accelerator devices 110. For example, in connection with providing a secure enclave, one or more accelerator devices 110 can include circuitry to perform one or more of: copy data to memory (e.g., Intel® Data Streaming Accelerator (DSA)) or data compression, encryption/decryption, and cryptographic chaining. In some examples, network interface device 150 can include a packet processing pipeline (not shown) that can be programmed to apply a profile to add support for applied protocols, change applied protocols, or change default settings (e.g., Intel® Dynamic Device Personalization (DDP)). The profile can be changed to without rebooting system 100 or network interface device 120. In some examples, reliable transport protocol 140 can be specified by a profile. The programmable pipeline can perform packet modifications to translate APIs or packet content between reliable transport protocol 140 and the RDMA protocols utilized by one or more of processes 104.

Memory 108 can include one or more of: one or more registers, one or more cache devices (e.g., level 1 cache (L1), level 2 cache (L2), level 3 cache (L3), last level cache (LLC)), volatile memory device, non-volatile memory device, or persistent memory device. For example, memory 108 can include static random access memory (SRAM) memory technology or memory technology consistent with high bandwidth memory (HBM), or double data rate (DDR), among others. Memory 108 can store data to be transmitted, data received in packets, reliable connection context, and other metadata.

As described herein, system 100 can transmit packets or other communications using a reliable transport protocol 140 by network interface device 120 to system 160 via network interface device 150. Conversely, in some examples, in a similar manner as that utilized by system 100, system 160 can transmit packets or other communications to system 100 using reliable transport protocol 140. System 100 and system 150 need not both use translation technologies described herein. In some examples, a process executed by system 100 or system 160 can be written to utilize the reliable transport protocol 140 without use of an RDMA intercept 130.

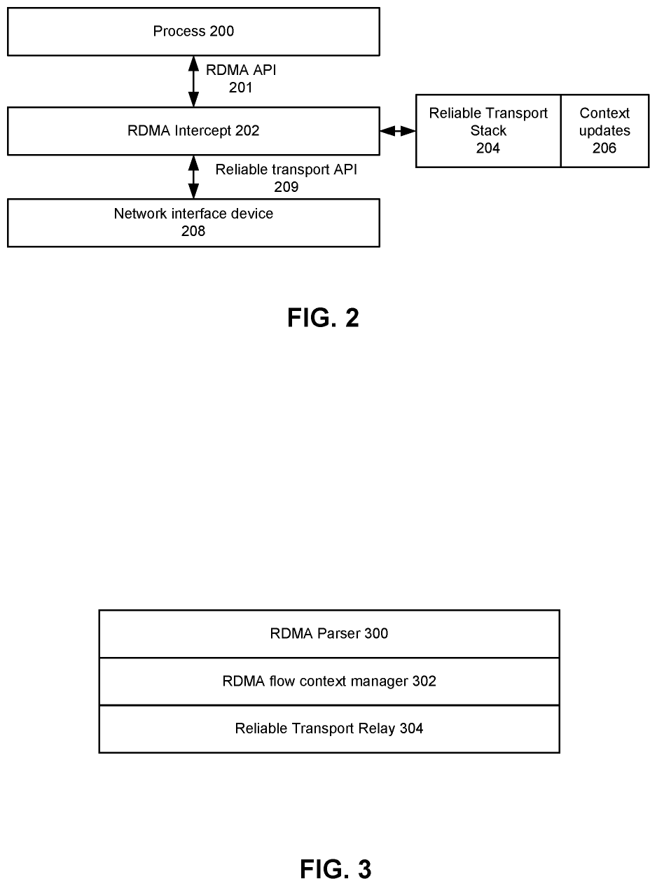

FIG. 2 depicts an example of communications. RDMA API 201 can provide communications between process 200 and RDMA intercept 202. RDMA API 201 can be consistent with RDMA verbs and can include one or more of: identification of a send queue (SQ), identification of a receive queue (RQ), shared receive queues (SRQs), identification of a completion queue (CQ), identification of a queue pair (QP) number, packet sequence number (PSN), target receiver address, destination address, connection description, open device, allocate, protected domain, memory regions (MRs), memory windows (MWs), address handles (AH), and so forth. For example, process 200 can issue requests to transmit data from memory by RDMA to a destination by issuing RDMA API 201 to network interface device 208, but RDMA intercept 202 can receive the RDMA API 201. RDMA intercept 202 can utilize reliable transport stack 204 to process the RDMA transmit request to translate the RDMA transmit request to a reliable transport API 209 based on a reliable transport protocol, such as a proprietary reliable transport protocol, utilized by network interface device 208 to communication with the destination. RDMA intercept 202 can update context for the RDMA data transmission in context updates 206, as described herein. Network interface device 208 can receive reliable transport API 209 and copy data and transmit data in one or more packets to the destination using the reliable transport protocol based on reliable transport API 209. For example, reliable transport API 209 can indicate one or more of fields of RDMA API 201, including one or more of: identification of a send queue (SQ), identification of a receive queue (RQ), shared receive queues (SRQs), identification of a completion queue (CQ), identification of a queue pair (QP) number, packet sequence number (PSN), target receiver address, destination address, connection description, open device, allocate, protected domain, memory regions (MRs), memory windows (MWs), address handles (AH), and so forth.

In connection with received RDMA communications from a sender, network interface device 208 can issue a reliable transport API 209 to process 200 to indicate receipt of an RDMA communication, but RDMA intercept 202 can receive reliable transport API 209. RDMA intercept 202 can utilize reliable transport stack 204 to process the received RDMA communications to provide an indication of receipt of an RDMA communication according to the RDMA protocol utilized by process 200 and provide the translated RDMA API as RDMA API 201 to process 200. RDMA intercept 202 can update context for the RDMA data receipt in context updates 206, as described herein. Network interface device 208 can copy data from the received RDMA communication for access by process 200.

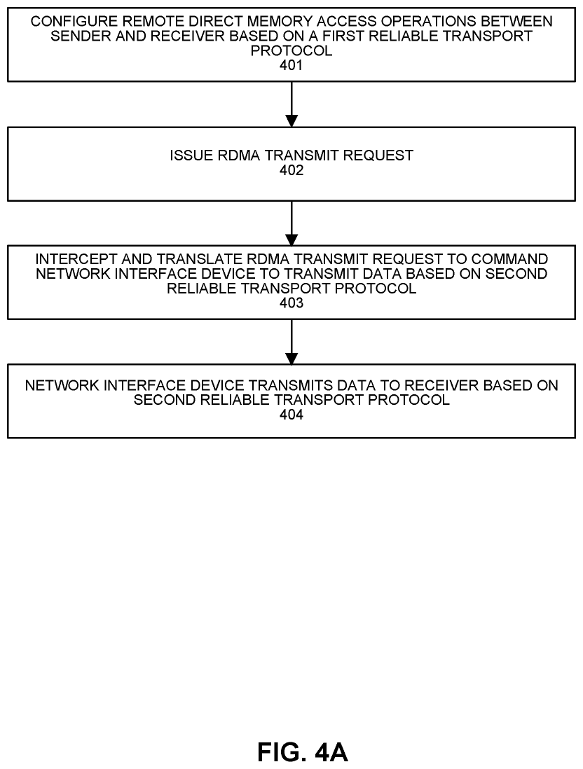

FIG. 3 depicts an example of components of an RDMA intercept. In connection with a packet transmission request, RDMA parser 300 can receive values in fields received in an RDMA API and provide the values or convert the values for use by a second, different, reliable transport protocol. In connection with a packet receipt, RDMA parser 300 can receive values in fields received in an RDMA API and provide the values or convert the values for use by a second, different, reliable transport protocol.

RDMA flow context manager 302 can update connection state related to transmitted and received packets sent over the second reliable transport protocol. In connection with a packet transmission request, reliable transport relay 304 can cause transmission of packets by the network interface device using the second reliable transport protocol based on the request received in the RDMA API. In connection with a packet receipt, reliable transport relay 304 can indicate to RDMA parser 300 and RDMA flow context manager 302 receipt of a packet and cause RDMA parser 300 to indicate packet receipt via the RDMA API and cause RDMA flow context manager 302 to update context data.

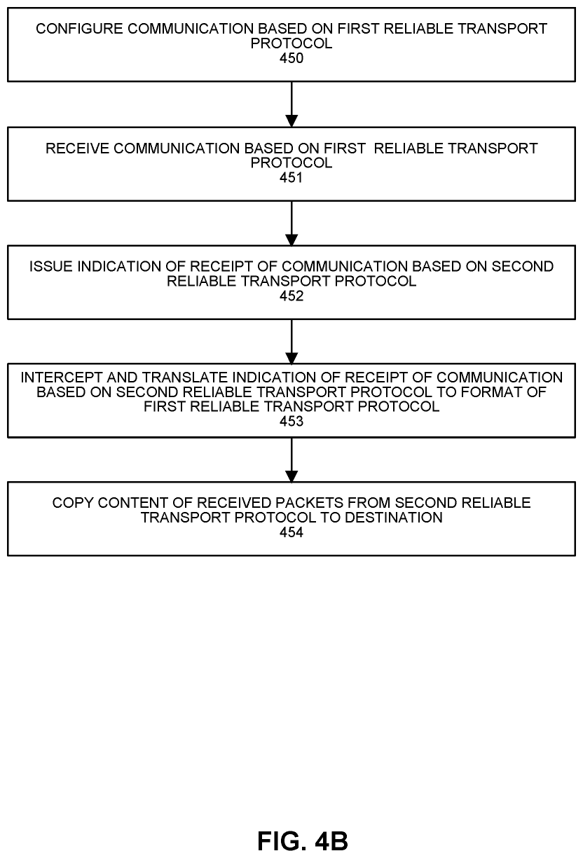

FIG. 4A depicts an example operation for packet transmission using a reliable transport protocol that differs from a reliable transport protocol utilized by a sender process. At 401, the sender process can configure RDMA operations in accordance with a first reliable transport protocol. Transmit requests can be based on the first reliable transport protocol can include one or more of: RDMA, InfiniBand, RoCE, TCP, QUIC, UDP, and others. For example, send queue and completion queue pairs can be setup at sender and receiver platforms. At 402, a process can issue an RDMA transmit request to a network interface device via an API or by providing the request to an OS or network interface device driver. At 403, an RDMA intercept can access the RDMA transmit request and cause the network interface device to transmit data referenced by the transmit request based on a second reliable transport protocol. The second reliable transport protocol can differ from that of the first reliable transport protocol utilized by the sender process. In addition, RDMA intercept can update connection state for the first reliable transport protocol utilized by a process, such as one or more of: received acknowledgements (ACKs), congestion window updates, and others. At 404, network interface device can transmit one or more packets to the destination receiver device in accordance with the second reliable transport protocol, which differs from the protocol utilized by the sender process.

FIG. 4B depicts an example operation in connection with packet receipt using a reliable transport protocol that differs from a reliable transport protocol utilized by a receiver process. At 450, the receiver process can configure RDMA operations in accordance with an applicable first reliable transport protocol. In some examples, the receiver process can be the same or different than that referenced in 402. Received requests can be based on a reliable transport protocol, including one or more of: RDMA, InfiniBand, RoCE, TCP, QUIC, UDP, or others. For example, send queue and completion queue pairs can be setup at receiver and sender platforms. At 451, the network interface device can receive a communication of one or more packets consistent with a second reliable transport protocol. The second reliable transport protocol can differ from the first reliable transport protocol utilized by a receiver process.

At 452, the network interface device can issue a reliable transport protocol receipt indication request in accordance with the first reliable transport protocol via an API or by providing the indication to the receiver process, OS, or network interface device driver. At 453, an RDMA intercept can access the reliable transport protocol receipt indication in accordance with the second reliable transport protocol and issue a corresponding receipt indication in accordance with the first reliable transport protocol. For example, the RDMA intercept can issue a corresponding RoCE verbs APIs to indicate that RoCE data has arrived even though data arrived via a reliable transport protocol other than RoCE. Accordingly, the applicable reliable transport protocol can be compatible with RoCE applications even though no RoCE packets were not transmitted or generated. In addition, RDMA intercept can update connection state for the first reliable transport protocol utilized by a receiver process, such as one or more of: received acknowledgements (ACKs), congestion window updates.

At 454, the network interface device can parse the one or more packets to determine the receiver process and destination memory location to store contents of the one or more packets. For example, the network interface device can utilize direct data placement (DDP) to copy the packet contents to memory associated with the first reliable transport protocol utilized by a receiver process. For example, the RDMA intercept can issue receive (RX) completion indications via a completion queue (CQ) using interrupts and/or Linux® New API (NAPI) polling (depending on the OS). The OS and driver can communication according to a first reliable transport protocol such as RoCE but the underlying second reliable transport protocol can be different than RoCE and can change.

FIG. 5A depicts an example of authentication and attestation operations in connection with packet receipt for a network interface device to limit access to a memory of a secure computing environment. The device authentication and attestation operations can be performed at the initiation of a process; however, these can be performed as demanded by the application owner or tenant. At 502, a network interface device can be authenticated by the process that has been assigned use of the network interface device, through use of device specific identity and certificates to access an addressable memory region associated with a destination process. At 504, based on authentication of the network interface device, an attestation of the destination process (e.g., application, container, microservice, VM, and so forth) and the host processor that executes the destination process can be performed. In some examples, the destination process can execute inside a confidential computing environment. Attestation of the destination process and the host processor can include an attestation quote, which is signed by the host processor. This processor signed quote can be delivered to an Attestation Server, which is managed by the application owner, and the Attestation Server can verify the signed quote.

At 506, based on authentication of the destination process and attestation of the destination process and the host processor and in response to a packet received using a reliable transport protocol, the network interface device can encrypt the received packet data and copy the received packet data to a buffer in destination memory associated with the destination process. For example, the network interface device and host system that executes the destination process inside a confidential computing environment can include circuitry to encrypt the data copied by a direct memory access (DMA) circuitry via a device interface link (e.g., PCIe) and provide replay protection using a link specific derived set of keys as well as memory-mapped I/O (MMIO) and network interface device configuration registers. Network interface device configuration registers can be protected from being altered by untrusted software by device circuitry that can detect register value alterations after those registers are locked and assigned to the process.

At 506, the network interface device can tag data streams copied to the host system with a specific header or metadata to uniquely identify a type and level of trust of the received data streams. A packet authentication tag can be calculated over the encrypted packet and carried within the packet headers. The packet authentication tag can be used by the host system to detect packet alterations or sequencing changes to detect out of order and replay attacks. The network interface device may be granted a higher level of trust, by a policy that is set within the network interface device upon successful attestation, to provide data to some enclaves but not other enclaves. The destination process can decrypt the data in connection with accessing the data.

FIG. 5B depicts an example process to authenticate operations in connection with packet transmission. At 550, a network interface device can be authenticated by a process that assigned to use to the network interface device, through use of device specific identity and certificates to access an addressable memory region associated with a sender process. At 552, based on authentication of the network interface device, attestation of the sender process (e.g., application, container, microservice, VM, and so forth) and the host processor that executes the sender process can be performed. In some examples, the sender process can execute inside a confidential computing environment. Attestation of the sender process and the host processor can include an attestation quote, signed by the host processor. This processor signed quote can be delivered to an Attestation Server, which is managed by the application owner, and the Attestation Server can verify the signed quote.

At 554, based on authentication of the sender process and attestation of the sender process and the host processor and in response to a request to transmit a packet by the sender process, the network interface device can encrypt the packet data and copy the encrypted packet data to form a packet for transmission using a reliable transport protocol. For example, the network interface device can include circuitry to encrypt the data copied by a direct memory access (DMA) circuitry via a device interface link (e.g., PCIe) and provide replay protection using a link specific derived set of keys as well as memory-mapped I/O (MMIO) and network interface device configuration registers. Network interface device configuration registers can be protected from being altered by untrusted software by device circuitry that can detect register value alterations after those registers are locked and assigned to the process. The network interface device can decrypt the data prior to transmission of the data for inclusion in packets transmitted using a reliable transport protocol.

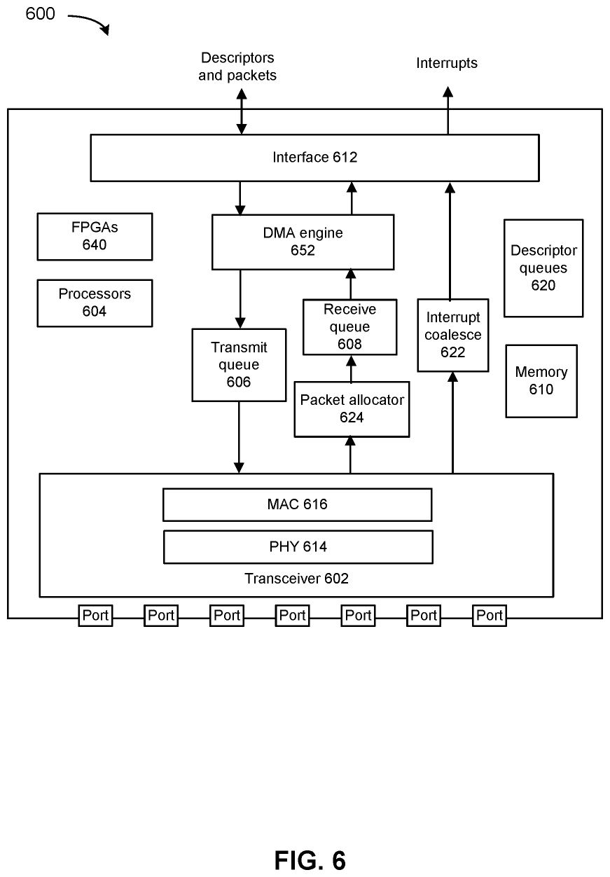

FIG. 6 depicts an example network interface device. In some examples, processors 604 and/or FPGAs 640 can be configured to perform translation of reliable transport semantics based on a first protocol to reliable transport semantics based on a second protocol, or translation of reliable transport semantics based on the second protocol to reliable transport semantics based on the first protocol, as described herein. Moreover, network interface 600 can transmit and receive packets based on the second protocol.

Some examples of network interface 600 are part of an Infrastructure Processing Unit (IPU) or data processing unit (DPU) or utilized by an IPU or DPU. An xPU can refer at least to an IPU, DPU, graphics processing unit (GPU), general purpose GPU (GPGPU), or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 600 can include transceiver 602, processors 604, transmit queue 606, receive queue 608, memory 610, and bus interface 612, and DMA engine 652. Transceiver 602 can be capable of receiving and transmitting packets in conformance with the applicable protocols such as Ethernet as described in IEEE 802.3, although other protocols may be used. Transceiver 602 can receive and transmit packets from and to a network via a network medium (not depicted). Transceiver 602 can include PHY circuitry 614 and media access control (MAC) circuitry 616. PHY circuitry 614 can include encoding and decoding circuitry (not shown) to encode and decode data packets according to applicable physical layer specifications or standards. MAC circuitry 616 can be configured to perform MAC address filtering on received packets, process MAC headers of received packets by verifying data integrity, remove preambles and padding, and provide packet content for processing by higher layers. MAC circuitry 616 can be configured to assemble data to be transmitted into packets, that include destination and source addresses along with network control information and error detection hash values.

Processors 604 can be one or more of: combination of: a processor, core, graphics processing unit (GPU), field programmable gate array (FPGA), application specific integrated circuit (ASIC), or other programmable hardware device that allow programming of network interface 600. For example, a “smart network interface” or SmartNIC can provide packet processing capabilities in the network interface using processors 604.

Processors 604 can include a programmable processing pipeline that is programmable by Programming Protocol-independent Packet Processors (P4), SONiC, C, Python, Broadcom Network Programming Language (NPL), NVIDIA® CUDA®, NVIDIA® DOCA™ Infrastructure Programmer Development Kit (IPDK), or x86 compatible executable binaries or other executable binaries. A programmable processing pipeline can include one or more match-action units (MAUs) that can schedule packets for transmission using one or multiple granularity lists, as described herein. Processors, FPGAs, other specialized processors, controllers, devices, and/or circuits can be used utilized for packet processing or packet modification. Ternary content-addressable memory (TCAM) can be used for parallel match-action or look-up operations on packet header content. Processors 604 and/or FPGAs 640 can be configured to perform event detection and action.

Packet allocator 624 can provide distribution of received packets for processing by multiple CPUs or cores using receive side scaling (RSS). When packet allocator 624 uses RSS, packet allocator 624 can calculate a hash or make another determination based on contents of a received packet to determine which CPU or core is to process a packet.

Interrupt coalesce 622 can perform interrupt moderation whereby network interface interrupt coalesce 622 waits for multiple packets to arrive, or for a time-out to expire, before generating an interrupt to host system to process received packet(s). Receive Segment Coalescing (RSC) can be performed by network interface 600 whereby portions of incoming packets are combined into segments of a packet. Network interface 600 provides this coalesced packet to an application.

Direct memory access (DMA) engine 652 can copy a packet header, packet payload, and/or descriptor directly from host memory to the network interface or vice versa, instead of copying the packet to an intermediate buffer at the host and then using another copy operation from the intermediate buffer to the destination buffer.

Memory 610 can be any type of volatile or non-volatile memory device and can store any queue or instructions used to program network interface 600. Transmit traffic manager can schedule transmission of packets from transmit queue 606. Transmit queue 606 can include data or references to data for transmission by network interface. Receive queue 608 can include data or references to data that was received by network interface from a network. Descriptor queues 620 can include descriptors that reference data or packets in transmit queue 606 or receive queue 608. Bus interface 612 can provide an interface with host device (not depicted). For example, bus interface 612 can be compatible with or based at least in part on PCI, PCIe, PCI-x, Serial ATA, and/or USB (although other interconnection standards may be used), or proprietary variations thereof.

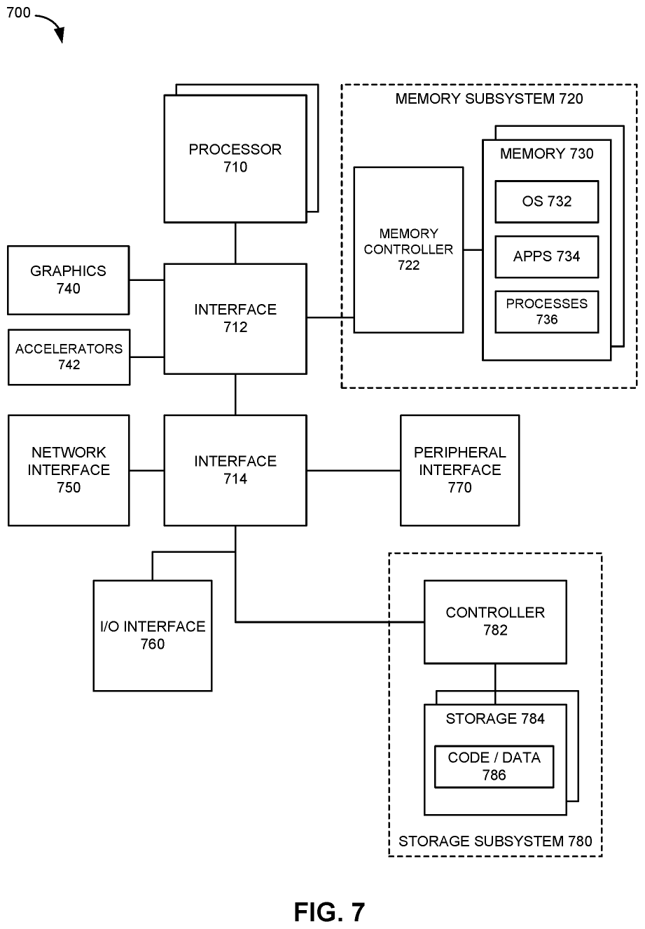

FIG. 7 depicts an example computing system. Components of system 700 (e.g., processor 710, accelerators 742, network interface 750, and so forth) can be configured to request transmission of data using reliable transport semantics for a reliable transport of the data using a first protocol but network interface 750 can utilize a second different protocol for reliable transport of the data or network interface 750 can receive data based on the second different protocol and indicate receipt of the data based on reliable transport semantics of the first protocol, as described herein. System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a fixed function or programmable offload engine that can be accessed or used by a processor 710. For example, an accelerator among accelerators 742 can provide compression (DC) capability, cryptography services such as public key encryption (PKE), cipher, hash/authentication capabilities, decryption, or other capabilities or services. In some embodiments, in addition or alternatively, an accelerator among accelerators 742 provides field select controller capabilities as described herein. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 742 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

Application 734 can request transmission of data using reliable transport semantics for a reliable transport of the data using a first protocol but network interface 750 can utilize a second different protocol for reliable transport of the data or network interface 750 can receive data based on the second different protocol and indicate receipt of the data to application 734 based on reliable transport semantics of the first protocol, as described herein. In some examples, OS 732, accelerators 742, and/or network interface 750 can perform translation of reliable transport semantics based on the first protocol to reliable transport semantics based on the second protocol, or translation of reliable transport semantics based on the second protocol to reliable transport semantics based on the first protocol.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory.

Network interface 750 can include one or more of: a network interface controller (NIC), a remote direct memory access (RDMA)-enabled NIC, SmartNIC, router, switch, or network-attached appliance. Some examples of network interface 750 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. Dynamic volatile memory uses refreshing the data stored in the device to maintain state. One example of dynamic volatile memory incudes DRAM (Dynamic Random Access Memory), or some variant such as Synchronous DRAM (SDRAM). An example of a volatile memory include a cache. A memory subsystem as described herein may be compatible with a number of memory technologies, such as those consistent with specifications from JEDEC (Joint Electronic Device Engineering Council) or others or combinations of memory technologies, and technologies based on derivatives or extensions of such specifications.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), a combination of one or more of the above, or other memory.

A power source (not depicted) provides power to the components of system 700. More specifically, power source typically interfaces to one or multiple power supplies in system 700 to provide power to the components of system 700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), Universal Chiplet Interconnect Express (UCIe), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network that provides die-to-die communications; chip-to-chip communications; circuit board-to-circuit board communications; and/or package-to-package communications.

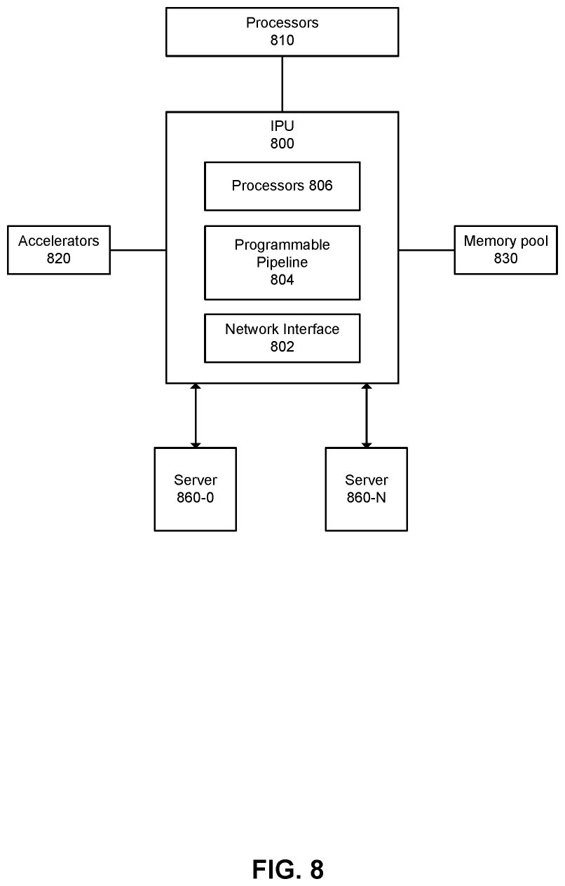

FIG. 8 depicts an example system. In this system, IPU 800 manages performance of one or more processes using one or more of processors 806, processors 810, accelerators 820, memory pool 830, or servers 840-0 to 840-N, where N is an integer of 1 or more. In some examples, processors 806 of IPU 800 can execute one or more processes, applications, VMs, containers, microservices, and so forth that request performance of workloads by one or more of: processors 810, accelerators 820, memory pool 830, and/or servers 840-0 to 840-N. IPU 800 can utilize network interface 802 or one or more device interfaces to communicate with processors 810, accelerators 820, memory pool 830, and/or servers 840-0 to 840-N. IPU 800 can utilize programmable pipeline 804 to process packets that are to be transmitted from network interface 802 or packets received from network interface 802. Programmable pipeline 804 and/or processors 806 can be configured to perform translation of reliable transport semantics based on a first protocol to reliable transport semantics based on a second protocol, or translation of reliable transport semantics based on the second protocol to reliable transport semantics based on the first protocol, as described herein. Moreover, IPU 800 can transmit and receive packets based on the second protocol, as described herein.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples, and includes an apparatus comprising: a network interface device comprising: circuitry to: receive a request to transmit data, based on a first reliable transport protocol, and cause the data to be transmitted in at least one packet, based on a second reliable transport protocol, to a destination device and receive at least one packet, from a sender device, based on the second reliable transport protocol and indicate receipt of the at least one packet, based on the first reliable transport protocol, wherein the first reliable transport protocol is different than the second reliable transport protocol.

Example 2 includes one or more examples, wherein the request to transmit data, based on a first reliable transport protocol comprises one or more of: a remote direct memory access (RDMA) Verbs application program interface (API) or InfiniBand Verbs API.

Example 3 includes one or more examples, wherein the first reliable transport protocol comprises one or more of: InfiniBand, Internet Wide Area remote direct memory access (RDMA) Protocol (iWARP), RDMA over Converged Ethernet (RoCE), Transmission Control Protocol (TCP), User Datagram Protocol (UDP), or quick UDP Internet Connections (QUIC).

Example 4 includes one or more examples, wherein the second reliable transport protocol comprises one or more of: a cloud service provider (CSP) proprietary protocol, resilient reliable protocol, InfiniBand, Internet Wide Area remote direct memory access (RDMA) Protocol (iWARP), RDMA over Converged Ethernet (RoCE), Transmission Control Protocol (TCP), routable RDMA over Converged Ethernet (RoCE), User Datagram Protocol (UDP), or quick UDP Internet Connections (QUIC).

Example 5 includes one or more examples, wherein the network interface device comprises second circuitry to: based on authentication of the network interface device to access memory associated with a confidential computing environment: encrypt the data associated with the request to transmit data and copy the encrypted data from a memory device associated with the confidential computing environment and encrypt data associated with the received at least one packet and copy the encrypted data to the memory device associated with the confidential computing environment.

Example 6 includes one or more examples, wherein the network interface device is associated with different levels of memory access rights for different confidential computing environments.

Example 7 includes one or more examples, wherein the circuitry is to permit a process to transmit and receive data using application program interfaces (API) semantics of the first reliable transport protocol and the network interface device to use the second reliable transport protocol to transmit and receive data with a destination device.

Example 8 includes one or more examples, wherein the network interface device includes one or more of: a network interface controller (NIC), a remote direct memory access (RDMA)-enabled NIC, SmartNIC, data processing unit (DPU), infrastructure processing unit (IPU), router, switch, or network-attached appliance.

Example 9 includes one or more examples, and includes a server comprising at least one processor and at least one memory device, wherein the at least one processor is to execute a process to request to transmit data stored in the at least one memory device and receive indication of receipt of the at least one packet from the network interface device.

Example 10 includes one or more examples, and includes a second server comprising at least one processor and at least one memory device, wherein the second server comprises the destination device.

Example 11 includes one or more examples, and includes a computer-readable medium, comprising instructions stored thereon, that if executed by one or more processors, cause the one or more processors to: configure a network interface device to: receive a request to transmit data, based on a first reliable transport protocol, and cause the data to be transmitted in at least one packet, based on a second reliable transport protocol, to a destination device and receive at least one packet, from a sender device, based on the second reliable transport protocol and indicate receipt of the at least one packet, based on the first reliable transport protocol, wherein the first reliable transport protocol is different than the second reliable transport protocol.

Example 12 includes one or more examples, wherein the request to transmit data, based on a first reliable transport protocol comprises one or more of: a remote direct memory access (RDMA) Verbs application program interface (API) or InfiniBand Verbs API.

Example 13 includes one or more examples, wherein the first reliable transport protocol comprises one or more of: InfiniBand, Internet Wide Area remote direct memory access (RDMA) Protocol (iWARP), RDMA over Converged Ethernet (RoCE), routable RDMA over Converged Ethernet (RoCE), Transmission Control Protocol (TCP), User Datagram Protocol (UDP), or quick UDP Internet Connections (QUIC).

Example 14 includes one or more examples, wherein the second reliable transport protocol comprises one or more of: a cloud service provider (CSP) proprietary protocol, resilient reliable protocol, InfiniBand, Internet Wide Area remote direct memory access (RDMA) Protocol (iWARP), RDMA over Converged Ethernet (RoCE), Transmission Control Protocol (TCP), routable RDMA over Converged Ethernet (RoCE), User Datagram Protocol (UDP), or quick UDP Internet Connections (QUIC).

Example 15 includes one or more examples, and includes instructions stored thereon, that if executed by one or more processors, cause the one or more processors to: grant the network interface device different levels of memory access rights for different confidential computing environments.

Example 16 includes one or more examples, and includes instructions stored thereon, that if executed by one or more processors, cause the one or more processors to: configure the network interface device to: encrypt the data associated with the request to transmit data and copy the encrypted data from a memory device associated with a confidential computing environment and encrypt data associated with the received at least one packet and copy the encrypted data to the memory device associated with the confidential computing environment.

Example 17 includes one or more examples, and includes a method comprising: a network interface device receiving a request to transmit data, based on a first reliable transport protocol, and cause the data to be transmitted in at least one packet, based on a second reliable transport protocol, to a destination device and the network interface device receiving at least one packet, from a sender device, based on the second reliable transport protocol and indicate receipt of the at least one packet, based on the first reliable transport protocol, wherein the first reliable transport protocol is different than the second reliable transport protocol.

Example 18 includes one or more examples, wherein the request to transmit data, based on a first reliable transport protocol comprises one or more of: a remote direct memory access (RDMA) Verbs application program interface (API) or InfiniBand Verbs API.

Example 19 includes one or more examples, wherein the first reliable transport protocol comprises one or more of: InfiniBand, Internet Wide Area remote direct memory access (RDMA) Protocol (iWARP), RDMA over Converged Ethernet (RoCE), Transmission Control Protocol (TCP), User Datagram Protocol (UDP), or quick UDP Internet Connections (QUIC).

Example 20 includes one or more examples, wherein the second reliable transport protocol comprises one or more of: a cloud service provider (CSP) proprietary protocol, resilient reliable protocol, InfiniBand, Internet Wide Area remote direct memory access (RDMA) Protocol (iWARP), RDMA over Converged Ethernet (RoCE), Transmission Control Protocol (TCP), routable RDMA over Converged Ethernet (RoCE), User Datagram Protocol (UDP), or quick UDP Internet Connections (QUIC).

What is claimed is:

1. An apparatus comprising:
a network interface device comprising:
circuitry to:
receive a request to transmit data, based on a first reliable transport protocol, and cause the data to be transmitted in at least one packet, based on a second reliable transport protocol, to a destination device and
receive at least one packet, from a sender device, based on the second reliable transport protocol and indicate receipt of the at least one packet, based on the first reliable transport protocol, wherein the first reliable transport protocol is different than the second reliable transport protocol.

2. The apparatus of claim 1, wherein the request to transmit data, based on a first reliable transport protocol comprises one or more of: a remote direct memory access (RDMA) Verbs application program interface (API) or InfiniBand Verbs API.

3. The apparatus of claim 1, wherein the first reliable transport protocol comprises one or more of: InfiniBand, Internet Wide Area remote direct memory access (RDMA) Protocol (iWARP), RDMA over Converged Ethernet (RoCE), Transmission Control Protocol (TCP), User Datagram Protocol (UDP), or quick UDP Internet Connections (QUIC).

4. The apparatus of claim 1, wherein the second reliable transport protocol comprises one or more of: a cloud service provider (CSP) proprietary protocol, resilient reliable protocol, InfiniBand, Internet Wide Area remote direct memory access (RDMA) Protocol (iWARP), RDMA over Converged Ethernet (RoCE), Transmission Control Protocol (TCP), routable RDMA over Converged Ethernet (RoCE), User Datagram Protocol (UDP), or quick UDP Internet Connections (QUIC).

5. The apparatus of claim 1, wherein the network interface device comprises second circuitry to:
based on authentication of the network interface device to access memory associated with a confidential computing environment:
encrypt the data associated with the request to transmit data and copy the encrypted data from a memory device associated with the confidential computing environment and
encrypt data associated with the received at least one packet and copy the encrypted data to the memory device associated with the confidential computing environment.

6. The apparatus of claim 1, wherein the network interface device is associated with different levels of memory access rights for different confidential computing environments.

7. The apparatus of claim 1, wherein the circuitry is to permit a process to transmit and receive data using application program interfaces (API) semantics of the first reliable transport protocol and the network interface device to use the second reliable transport protocol to transmit and receive data with a destination device.

8. The apparatus of claim 1, wherein the network interface device includes one or more of: a network interface controller (NIC), a remote direct memory access (RDMA)-enabled NIC, SmartNIC, data processing unit (DPU), infrastructure processing unit (IPU), router, switch, or network-attached appliance.

9. The apparatus of claim 1, comprising a server comprising at least one processor and at least one memory device, wherein the at least one processor is to execute a process to request to transmit data stored in the at least one memory device and receive indication of receipt of the at least one packet from the network interface device.

10. The apparatus of claim 9, comprising a second server comprising at least one processor and at least one memory device, wherein the second server comprises the destination device.

11. A computer-readable medium, comprising instructions stored thereon, that if executed by one or more processors, cause the one or more processors to:
configure a network interface device to:
receive a request to transmit data, based on a first reliable transport protocol, and cause the data to be transmitted in at least one packet, based on a second reliable transport protocol, to a destination device and
receive at least one packet, from a sender device, based on the second reliable transport protocol and indicate receipt of the at least one packet, based on the first reliable transport protocol, wherein the first reliable transport protocol is different than the second reliable transport protocol.

12. The computer-readable medium of claim 11, wherein the request to transmit data, based on a first reliable transport protocol comprises one or more of: a remote direct memory access (RDMA) Verbs application program interface (API) or InfiniBand Verbs API.

13. The computer-readable medium of claim 11, wherein the first reliable transport protocol comprises one or more of: InfiniBand, Internet Wide Area remote direct memory access (RDMA) Protocol (iWARP), RDMA over Converged Ethernet (RoCE), routable RDMA over Converged Ethernet (RoCE), Transmission Control Protocol (TCP), User Datagram Protocol (UDP), or quick UDP Internet Connections (QUIC).

14. The computer-readable medium of claim 11, wherein the second reliable transport protocol comprises one or more of: a cloud service provider (CSP) proprietary protocol, resilient reliable protocol, InfiniBand, Internet Wide Area remote direct memory access (RDMA) Protocol (iWARP), RDMA over Converged Ethernet (RoCE), Transmission Control Protocol (TCP), routable RDMA over Converged Ethernet (RoCE), User Datagram Protocol (UDP), or quick UDP Internet Connections (QUIC).

15. The computer-readable medium of claim 11, comprising instructions stored thereon, that if executed by one or more processors, cause the one or more processors to:
grant the network interface device different levels of memory access rights for different confidential computing environments.

16. The computer-readable medium of claim 11, comprising instructions stored thereon, that if executed by one or more processors, cause the one or more processors to:
configure the network interface device to:
encrypt the data associated with the request to transmit data and copy the encrypted data from a memory device associated with a confidential computing environment and
encrypt data associated with the received at least one packet and copy the encrypted data to the memory device associated with the confidential computing environment.

17. A method comprising:
a network interface device receiving a request to transmit data, based on a first reliable transport protocol, and cause the data to be transmitted in at least one packet, based on a second reliable transport protocol, to a destination device and
the network interface device receiving at least one packet, from a sender device, based on the second reliable transport protocol and indicate receipt of the at least one packet, based on the first reliable transport protocol, wherein the first reliable transport protocol is different than the second reliable transport protocol.

18. The method of claim 17, wherein the request to transmit data, based on a first reliable transport protocol comprises one or more of: a remote direct memory access (RDMA) Verbs application program interface (API) or InfiniBand Verbs API.

19. The method of claim 17, wherein the first reliable transport protocol comprises one or more of: InfiniBand, Internet Wide Area remote direct memory access (RDMA) Protocol (iWARP), RDMA over Converged Ethernet (RoCE), Transmission Control Protocol (TCP), User Datagram Protocol (UDP), or quick UDP Internet Connections (QUIC).

20. The method of claim 17, wherein the second reliable transport protocol comprises one or more of: a cloud service provider (CSP) proprietary protocol, resilient reliable protocol, InfiniBand, Internet Wide Area remote direct memory access (RDMA) Protocol (iWARP), RDMA over Converged Ethernet (RoCE), Transmission Control Protocol (TCP), routable RDMA over Converged Ethernet (RoCE), User Datagram Protocol (UDP), or quick UDP Internet Connections (QUIC).
